(19) United States
(12) Patent Application Publication
(10) Pub. No.: US 2026/0151971 A1
(43) Pub. Date: Jun. 4, 2026

(54) Tire Sealant Container for a Flat Tire Repair Kit

(71) Applicant: Illinois Tool Works Inc., Glenview, IL (US)

(72) Inventors: William Craig Keller, Medway, MA (US); Martin Patrick Spindler, Herdwangen-Schönach (DE); Bruno Schulze Selting, Rielasingen-Worblingen (DE); Alexander Limpert, Weikersheim (DE); Albert Sbongk, Niederstetten (DE); Dilara Sedir, Meersburg (DE)

(21) Appl. No.: 19/391,474

(22) Filed: Nov. 17, 2025

Related U.S. Application Data
(60) Provisional application No. 63/727,419, filed on Dec. 3, 2024.

(51) Int. Cl. B29C 73/16; B29L 30/00

(52) U.S. Cl. CPC B29C 73/166; B29L 2030/00

(57) ABSTRACT

A tire sealant container (1) for a flat tire repair kit. The tire sealant container (1) includes a hollow body, which is at least partially or regionally in particular cylindrical and preferably circularly cylindrical, having a bottom-side lower container portion (2), a lid-side upper container portion (3), and a sheath part (4) connecting the lower container portion (2) to the upper container portion (3). The lid-side upper container portion (3) is beaded with an upper flanged rim (5) on a lid-side edge region of the sheath part (4), preferably with the interposed clamping of a circumferential seal (6).

### RELATED APPLICATIONS

The present application claims priority to U.S. Provisional Patent Application No. 63/727,419, filed Dec. 3, 2024, and entitled “Tire Sealant Container for a Flat Tire Repair Kit,” which is hereby incorporated by reference in its entirety.

### BACKGROUND

Conventional apparatuses for extracting tire sealants from tire sealant containers, and in particular from pressure-resistant containers, are known and available on the market in a variety of forms and designs. These are mostly used in combination with a compressor as a flat tire set in vehicles, instead of integrated spare tires.

The tire sealant container typically must be connected to the compressor and set up in a complicated manner in order to ensure that tire sealant is extracted from the tire sealant container. In this regard, tire sealant containers are known that must be set up standing or set up upside-down and connected to a pressure source in order to pump tire sealant out of the tire sealant container into a vehicle tire in the event of a flat tire.

What is disadvantageous in conventional apparatuses is that the compressor can only be connected to the tire sealant container with great effort with valves, changeover valves, mechanical devices, etc., in order to pressurize the tire sealant container in order to pump tire sealant out of it and into a defective tire. In addition, conventional tire sealant containers are costly to install, complicated to operate, and much too heavy and too expensive when manufacturing.

In particular, the disadvantage of conventional systems and in particular tire sealant containers are that they are relatively large, complexly designed, relatively expensive to manufacture, and take up a lot of room in a design space of a vehicle, for example in a region of a trunk.

### SUMMARY

The present disclosure relates generally to a tire sealant container, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates, schematically and in a side view, an exemplary embodiment of the tire sealant container according to the disclosure.

FIG. 2 illustrates, schematically, a sectional view along line A-A in FIG. 1 of the exemplary embodiment of the tire sealant container according to the disclosure.

FIG. 3 illustrates, schematically, a view of the bottom-side lower container portion of the exemplary embodiment of the tire sealant container according to the disclosure.

FIG. 4 illustrates, schematically, a top plan view of the lid-side upper container portion of the exemplary embodiment of the tire sealant container according to the disclosure.

FIG. 5 illustrates, schematically, a detailed view of the upper flanged rim of the exemplary embodiment of the tire sealant container according to the disclosure.

FIG. 6 illustrates, schematically, a detailed view of the lower flanged rim of the exemplary embodiment of the sealant container according to the present disclosure.

FIG. 7 illustrates, schematically, a detailed view of the adapter that is received in the lid-side upper container portion of the exemplary embodiment of the tire sealant container according to the disclosure, with the port for a connection line, in particular for a connection hose.

FIG. 8 illustrates, schematically, a detailed view of the port received in the bottom-side lower container portion of the exemplary embodiment of the tire sealant container according to the disclosure for a connection line that is preferably in fluid communication with an air compressor.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to flat tire repair kits and, in particular, to apparatuses for dispensing tire sealants out of a tire sealant container. In particular, the disclosure relates to a novel tire sealant container for a flat tire repair kit.

The present disclosure addresses, inter alia, the problem of specifying a tire sealant container, which eliminates the specified disadvantages and can be used in order to extract tire sealant into a defective tire in a simple and inexpensive manner, as needed. In doing so, the tire sealant container allows for a weight reduction of the overall flat tire repair kit, wherein the manufacturing costs are additionally to be lowered.

According to a first aspect, the problem underlying the disclosure is solved by a tire sealant container according to the independent claim 1.

Alternatively, or additionally, the problem underlying the disclosure is solved by a tire sealant container according to the parallel claim 2 or by the parallel claim 3.

According to a further aspect of the disclosure, the problem underlying the disclosure is solved by a tire sealant container according to the parallel claim 15.

Advantageous further developments of the tire sealant container according to the disclosure are specified in the dependent claims.

Accordingly, the disclosure relates in particular to a tire sealant container for a flat tire repair kit, wherein the tire sealant container comprises a hollow body, which is at least partially or regionally in particular cylindrical and preferably circularly cylindrical, having a bottom-side lower container portion, a lid-side upper container portion, and a sheath part connecting the lower container portion to the upper container portion.

According to a first aspect, it is provided in particular according to the present disclosure that the lid-side upper container portion is beaded with an upper flanged rim on a lid-side edge region of the sheath part, in particular with the interposed clamping of a circumferential seal.

Alternatively, or additionally, it is provided that the bottom-side lower container portion is beaded with a lower flanged rim on a bottom-side edge region of the sheath part, preferably with the interposed clamping of a circumferential seal.

In other words, according to aspects of the present disclosure, a tire-sealant container is provided, which can be manufactured in a particularly easy-to-implement and thus inexpensive manner. As with a classical beverage can, the sheath part of the tire sealant container can be made of metallic sheet metal, wherein the lid-side upper container portion and/or the bottom-side lower container portion are connected to the sheath part via an upper and lower flanged rim, respectively.

According to a further alternative or additional aspect, the lid-side upper container portion can comprise a dome-shaped region that adjoins the upper flanged rim on the inside via a circumferential, upwardly open flute and is in particular convexly upwardly arched beyond an upper edge of the upper flanged rim, having an axially central and at least partially or regionally upwardly projecting adapter, which comprises a port for a connection line, in particular a connection hose.

The adapter comprising the port for a connection line is designed in particular as a plastic part, preferably as an injection-molded plastic part.

According to implementations of the adapter comprising the port for a connection line, it is provided that the adapter comprises a lower region, which tapers at least partially or regionally towards the bottom-side lower container portion and is in particular at least substantially frustoconical when viewed in the cross-section of the adapter, which region is received inside the tire sealant container, wherein the lower region of the adapter is connected to an upper region of the adapter projecting upwardly beyond the lid-side upper container portion via a circumferential, in particular flute-shaped edge region of the adapter.

In this respect, it can be appreciated that the dome-shaped region of the lid-side upper container portion that is in particular convexly upwardly arched beyond the upper edge of the upper flanged rim comprises an axially central reception opening, in which the adapter is inserted and held.

According to design variants, in particular of the most recently mentioned embodiment of the tire sealant container according to the disclosure, it is provided that an edge region of the axially central reception opening of the dome-shaped region of the lid-side upper container portion that is in particular convexly upwardly arched beyond the upper edge of the upper flanged rim is pressed and in particular bent, preferably beaded, into the circumferential, in particular flute-shaped edge region of the adapter, preferably with the interposed clamping of a circumferential seal.

Alternatively or additionally, the edge region of the axially central reception opening of the dome-shaped region of the lid-side upper container portion that is in particular convexly upwardly arched beyond the upper edge of the upper flanged rim can at least partially or regionally comprise a cross-sectional contour which is at least partially or regionally complementary to a cross-sectional contour of the circumferential, in particular flute-shaped edge region of the adapter.

It is particularly appreciated here that the circumferential, in particular flute-shaped edge region of the adapter has a circular segment-shaped cross-sectional contour.

According to embodiments of the tire sealant container according to the disclosure, it is provided that the edge region of the axially central reception opening of the dome-shaped region of the lid-side upper container portion that is in particular convexly upwardly arched beyond the upper edge of the upper flanged rim is curved outwardly in relation to the axially central reception opening.

The upper region of the adapter comprises in particular an axially central plug-in coupling port. However, other types of ports are contemplated, such as a bayonet port or jaw coupling port. The corresponding port of the adapter serves to releasably receive a connection line, in particular a connection hose.

The adapter preferably comprises a riser that is in particular configured integrally with the adapter and extends from the lower region of the adapter towards the bottom-side lower container portion and comprises an axially central fluid channel.

In this respect, it can be appreciated that the axially central, at least partially or regionally upwardly projecting upper region of the adapter comprises a fluid channel that is configured so as to be coaxial and/or concentric to the axially central fluid channel of the riser and is in fluid communication with the axially central fluid channel of the riser.

According to implementations of the tire sealant container according to the disclosure, it is provided that the adapter of the tire sealant container comprises a support structure or that a corresponding support structure is associated with the adapter. Using the support structure, the adapter supports itself beyond the upper region of the adapter on the dome-shaped region of the lid-side upper container portion that is in particular convexly upwardly arched beyond the upper edge of the upper flanged rim and in particular on a central region of the dome-shaped region of the lid-side upper container portion that is in particular convexly upwardly arched beyond the upper edge of the upper flanged rim.

According to a further aspect of the disclosure, it relates to a tire sealant container having an at least partially or regionally in particular cylindrical and preferably circular cylindrical hollow body comprising a bottom-side lower container portion, a lid-side upper container portion, and a sheath part connecting the lower container portion to the upper container portion.

In this further aspect of the disclosure, it is provided in particular that the bottom-side lower container portion of the tire sealant container comprises a port for a connection line, in particular a connection hose, which is in fluid communication with an air compressor.

In particular, in this aspect of the disclosure, it is provided that the lid-side upper container portion comprises a dome-shaped region that adjoins the upper flanged rim on the inside via a circumferential, upwardly open flute and is in particular convexly upwardly arched beyond an upper edge of the upper flanged rim, having an axially central and at least partially or regionally upwardly projecting adapter, which comprises a port for a connection line, in particular a connection hose.

In other words, in this configuration of the tire sealant container, the compressed air port of the tire sealant container is provided in the bottom-side lower container portion, while the tire sealant outlet is configured in the form of the adapter on the lid-side upper container portion.

This has the advantage that the connection line via which the tire sealant container is supplied with compressed air can be shortened, or such a connection line can be omitted altogether.

The port of the bottom-side lower container portion is formed in particular by an adapter connected to the bottom-side lower container portion.

The port of the bottom-side lower container portion is preferably arranged decentrally in relation to a longitudinal extension direction of the tire sealant container, wherein other design variants are also contemplated.

The bottom-side lower container portion preferably comprises a reception opening in which the port for the connection line, which is preferably in fluid communication with an air compressor, is inserted and held.

In this context, it can be appreciated that an edge region of the reception opening of the bottom-side lower container portion is preferably pressed into the port for the connection line that is preferably in fluid communication with an air compressor, preferably with the interposed clamping of a circumferential seal.

The edge region of the reception opening of the bottom-side lower container portion can be bent towards the lid-side upper container portion.

The port for the connection line that is preferably in fluid communication with an air compressor is configured as a female plug part. However, other design variants are also suitable here.

For the sake of stability and to improve the pressure resistance of the tire sealant container, the bottom-side lower container portion should be designed so as to convexly curve at least partially or regionally in the direction of the lid-side upper container portion.

In the interior of the tire sealant container, a tire sealant, which is liquid under atmospheric pressure and at least in a temperature range of about −30° C. to about +60° C., and no propellant gas is received.

According to realizations of the tire sealant container according to the disclosure, the tire sealant container has a total length of about 140 mm to about 250 mm, and preferably about 160 mm to about 230 mm, and a maximum diameter of about 50 mm to about 90 mm, and preferably about 60 mm to about 75 mm.

The exemplary embodiment of the tire sealant container 1 according to the present disclosure relates to a tire sealant container 1 for a flat tire repair kit. The tire sealant container 1 is configured so as to receive a tire sealant that is liquid under atmospheric pressure and at least in a temperature range of about −30° C. to about +60° C., wherein no propellant gas is required in order to expel the tire sealant.

The tire sealant container 1 according to the embodiment shown in the drawings has a total length of about 140 mm to about 250 mm, and preferably about 160 mm to about 230 mm, and a maximum diameter of about 50 mm to about 90 mm, and preferably about 60 mm to about 75 mm.

Briefly summarized, the exemplary embodiment of the tire sealant container 1 according to the disclosure is a hollow body, which is at least partially or regionally circularly cylindrical and is formed by a bottom-side lower container portion 2, a lid-side upper container portion 3, and a sheath part 4 that connects the lower container portion 2 to the upper container portion 3.

The lid-side upper container portion 3 is beaded with an upper flanged rim 5 on a lid-side edge region of the sheath part 4. Here, a circumferential seal 6 can be formed in the flanged rim 5, although this is not absolutely necessary.

The bottom-side lower container portion 2 is beaded with a lower flanged rim 7 on a bottom-side edge region of the sheath part 4, preferably with the interposed clamping of a circumferential seal 6.

As shown, the exemplary embodiment of the tire sealant container 1 according to the disclosure comprises a dome-shaped region 9 that is convexly upwardly arched beyond the upper edge of the upper flanged rim 5.

The convexly upwardly arched dome-shaped region 9 of the lid-side upper container portion 3 is connected to the upper flanged rim 5 of the tire sealant container 1 via a circumferential, upwardly open flute 8.

The convexly upwardly arched dome-shaped region 9 comprises an adapter 10 that comprises a port 11 for a connection line, in particular a connection hose, which is axially central in relation to the tire sealant container 1.

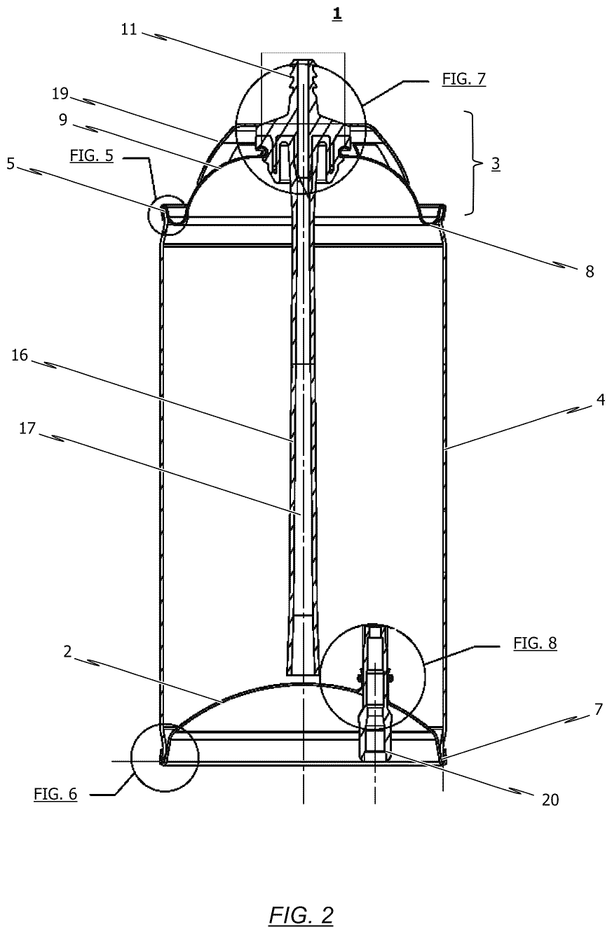

As can be seen in particular from the sectional view according to FIG. 2 or the detail view according to FIG. 7, the adapter 10 comprising the port 11 for a connection line is configured as a plastic part. In particular, the adapter 10 comprising the port 11 for a connection line is configured as an injection-molded plastic part.

Furthermore, the sectional view according to FIG. 2, and in particular the detail view according to FIG. 7, shows that the adapter 10 comprises a lower region 12, which tapers at least partially or regionally towards the bottom-side lower container portion 2 and is at least substantially frustoconical when viewed in the cross-section of the adapter 10. This lower region 12 of the adapter 10 is received inside the tire sealant container 1.

In particular, the detail view according to FIG. 7 shows that the lower region 12 of the adapter 10 is connected via a circumferential annular edge region 14 of the adapter 10 to an upper region 13 of the adapter 10, which projects upwardly beyond the lid-side upper container portion 3.

The dome-shaped region 9 of the lid-side upper container portion 3 that is convexly upwardly arched beyond the upper edge of the upper flanged rim 5 comprises an axially central reception opening, in which the adapter 10 is inserted and held.

Referring again to the detail view in FIG. 7, it is noted that an edge region of the axially central reception opening of the dome-shaped region 9 of the lid-side upper container portion 3 that is convexly upwardly arched beyond the upper edge of the upper flanged rim 5 is pressed and in particular bent into the circumferential flute-shaped edge region 14 of the adapter 10, with the interposed clamping of a circumferential seal 6.

The edge region of the axially central reception opening of the dome-shaped region 9 of the lid-side upper container portion 3 that is convexly upwardly arched beyond the upper edge of the upper flanged rim 5 comprises a cross-sectional contour which is complementary to a cross-sectional contour of the circumferential flute-shaped edge region of the adapter 10. A circular segment-shaped cross-sectional contour is used here.

The edge region of the axially central reception opening of the dome-shaped region 9 of the lid-side upper container portion 3 that is convexly upwardly arched beyond the upper edge of the upper flanged rim 5 is curved outwardly in relation to the axially central reception opening.

In the exemplary embodiment of the tire sealant container 1 according to the disclosure as shown in the drawings, the upper region 13 of the adapter 10 comprises an axially central plug-in coupling port. However, other types of ports are contemplated, such as a bayonet port or jaw coupling port.

The axially central plug-in coupling port 11 of the upper region 13 of the adapter 10 is used in order to connect a connection line, in particular a connection hose.

The sectional view according to FIG. 2 shows that the adapter 10 of the exemplary embodiment of the tire sealant container 1 according to the disclosure comprises a riser 16 that is formed integrally with the adapter 10 and extends from the lower region 12 of the adapter 10 towards the bottom-side lower container portion 2 and defines or comprises an axially central fluid channel 17.

Furthermore, the sectional view according to FIG. 2, and also the detail view according to FIG. 7, shows that the axially central, at least partially or regionally upwardly projecting upper region 13 of the adapter 10 comprises a fluid channel 18 that is configured so as to be coaxial and concentric to the axially central fluid channel 17 of the riser 16 and is in fluid communication with the axially central fluid channel 17 of the riser 16.

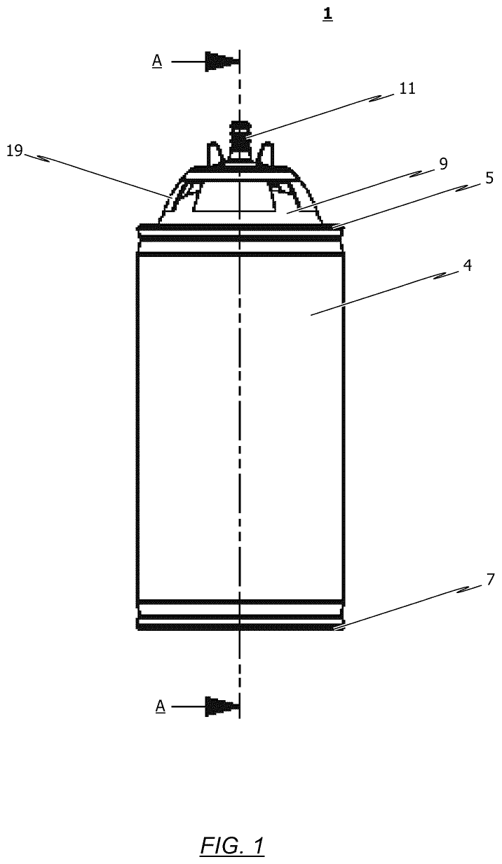

From the illustration according to FIG. 1 and according to FIG. 2, it can be seen that the exemplary embodiment of the tire sealant container 1 according to the disclosure comprises a support structure 19 associated with the adapter 10, via which the adapter 10 supports itself beyond the upper region 13 of the adapter 10 on a central region of the dome-shaped region 9 of the lid-side upper container portion 3 that is convexly upwardly arched beyond the upper edge of the upper flanged rim 5.

The exemplary embodiment of the tire sealant container 1 according to the disclosure shown in the drawings is in particular also wherein the bottom-side lower container portion 2 comprises a port 20 for a connection line that is in fluid communication with an air compressor or for an outlet of an air compressor.

The port 20 of the bottom-side lower container portion 2 is formed by an adapter connected to the bottom-side lower container portion 2.

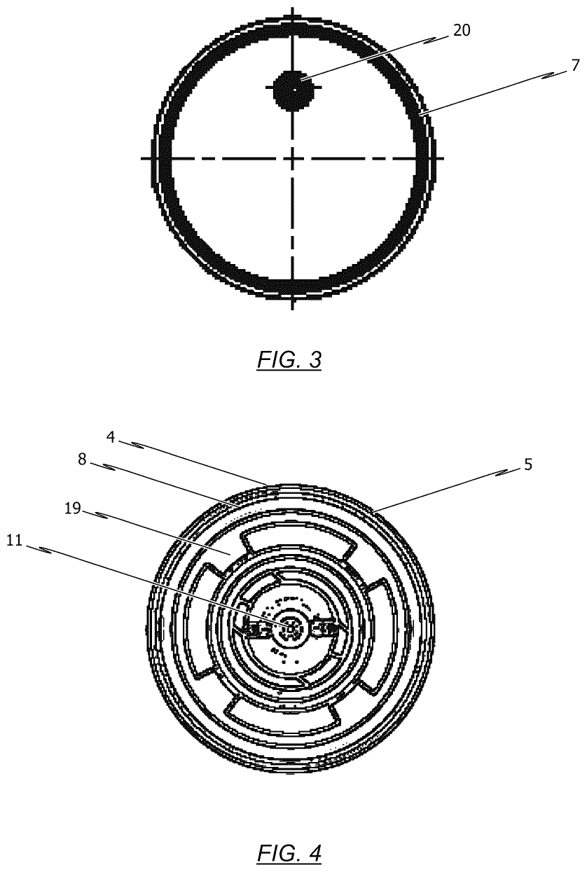

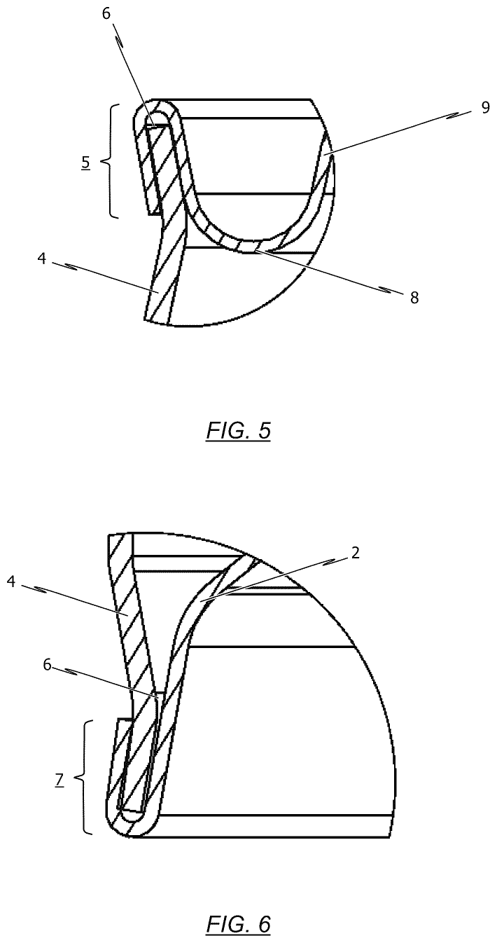

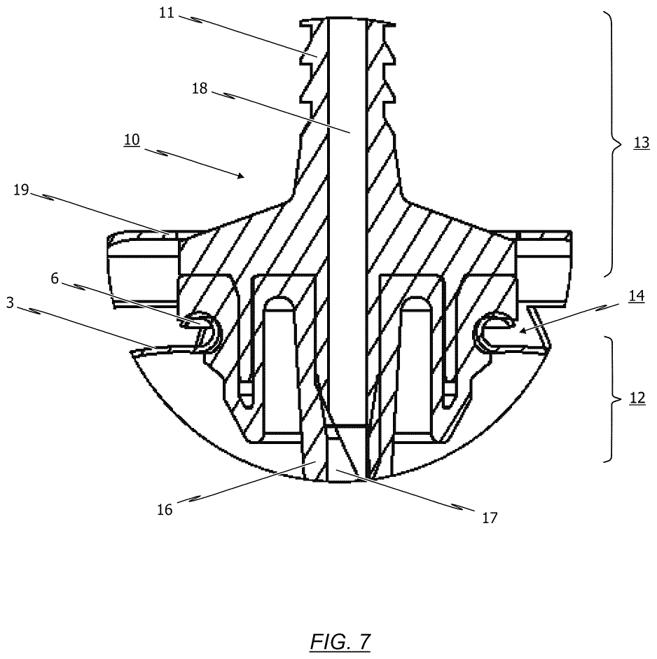

The top plan view according to FIG. 3 shows that the port 20 of the bottom-side lower container portion 2 is arranged decentrally in relation to a longitudinal extension direction of the tire sealant container 1.

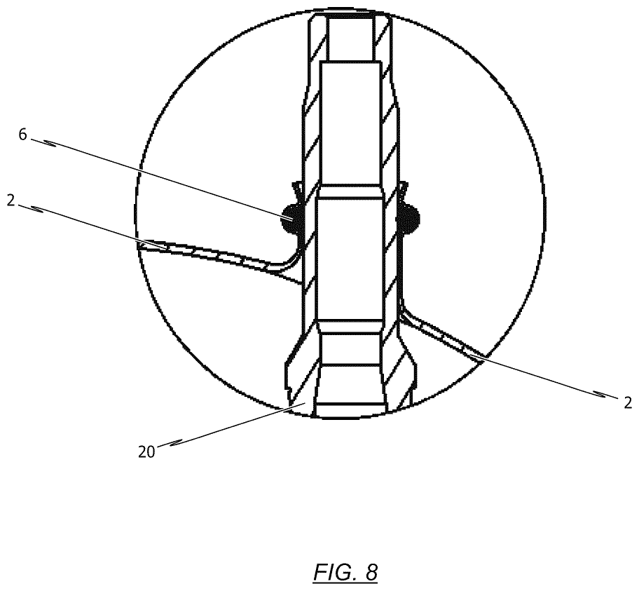

Referring to the detail view according to FIG. 8, it is noted that the bottom-side lower container portion 2 of the exemplary embodiment of the tire sealant container 1 according to the disclosure comprises a reception opening in which the port 20 for the connection line that is preferably in fluid communication with an air compressor, or directly an outlet of an air compressor, is inserted and held.

Here, an edge region of the reception opening of the bottom-side lower container portion 2 is pressed into the port 11 for the connection line that is in fluid communication with the air compressor or for the outlet of the air compressor, with the interposed clamping of a circumferential seal 6.

The edge region of the reception opening of the bottom-side lower container portion 2 is bent towards the lid-side upper container portion 3.

In the exemplary embodiment of the tire sealant container 1 according to the disclosure, the bottom-side lower container portion 2 is designed so as to curve convexly towards the lid-side upper container portion 3.

The port 20, which is received in the bottom-side lower container portion 2, is in particular configured as a female plug-in coupling port part.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Tire sealant container
2 Bottom-side lower container portion
3 Lid-side upper container portion
4 Sheath part
5 Upper flanged rim
6 Circumferential seal
7 Lower flanged rim
8 Flute opening upwards
9 Convexly upwardly arched dome-shaped region
10 Adapter
11 Port
12 Lower region of the adapter
13 Upper region of the adapter
14 Circumferential edge region of the adapter
16 Riser
17 Fluid channel of the riser
18 Fluid channel of the adapter
19 Support structure
20 Port in bottom-side lower container portion

What is claimed is:

1. A tire sealant container (1) for a flat tire repair kit, comprising:
a hollow body having a bottom-side lower container portion (2), a lid-side upper container portion (3), and a sheath part (4) connecting the lower container portion (2) to the upper container portion (3);
wherein the hollow body is at least partially cylindrical; and
wherein the lid-side upper container portion (3) includes a beaded upper flanged rim (5) formed on an edge region of the sheath part (4), with a circumferential seal (6) clamped therebetween.

2. The tire sealant container (1) of claim 1, wherein the bottom-side lower container portion (2) includes a beaded lower flanged rim (7) formed on a lower edge region of the sheath part (4), with a circumferential seal (6) clamped therebetween.

3. The tire sealant container (1) of claim 1, further comprising a dome-shaped region (9) of the lid-side upper container portion (3) adjoining the upper flanged rim (5) on an inner side through a circumferential, upwardly open flute (8), the dome-shaped region (9) including an axially central, upwardly projecting adapter (10) having a port (11) for a connection line.

4. The tire sealant container (1) of claim 3, wherein the adapter (10) is a plastic component, optionally an injection-molded plastic component.

5. The tire sealant container (1) of claim 3, wherein the adapter (10) includes a lower region (12) tapering toward the lower container portion (2), the lower region (12) being at least partially frustoconical in cross section, and an upper region (13) projecting upwardly beyond the upper container portion (3), the lower and upper regions being joined by a circumferential edge region (14).

6. The tire sealant container (1) of claim 5, wherein the dome-shaped region (9) includes an axially central reception opening in which the adapter (10) is inserted and held.

7. The tire sealant container (1) of claim 6, wherein an edge region of the reception opening of the dome-shaped region (9) is pressed or bent into the circumferential edge region (14) of the adapter (10), with a circumferential seal (6) clamped therebetween.

8. The tire sealant container (1) of claim 6, wherein the edge region of the reception opening of the dome-shaped region (9) has a cross-sectional contour that is at least partially complementary to a cross-sectional contour of the circumferential edge region (14) of the adapter (10).

9. The tire sealant container (1) of claim 6, wherein the circumferential edge region (14) of the adapter (10) has a circular segment-shaped cross-sectional contour.

10. The tire sealant container (1) of claim 6, wherein the edge region of the reception opening of the dome-shaped region (9) is curved outwardly relative to the axially central reception opening.

11. The tire sealant container (1) of claim 5, wherein the upper region (13) of the adapter (10) includes a coupling port selected from the group consisting of a plug-in coupling port, a bayonet port, and a jaw coupling port for a connection line.

12. The tire sealant container (1) of claim 5, wherein the adapter (10) includes a riser (16) integrally formed with the adapter (10) and extending from the lower region (12) toward the lower container portion (2), the riser (16) including an axially central fluid channel (17).

13. The tire sealant container (1) of claim 12, wherein the upper region (13) of the adapter (10) includes a fluid channel (18) coaxial with the fluid channel (17) of the riser (16) and in fluid communication therewith.

14. The tire sealant container (1) of claim 5, wherein the adapter (10) includes or is associated with a support structure (19) configured to support the adapter (10) on the dome-shaped region (9) of the upper container portion (3).

15. The tire sealant container (1) of claim 1, wherein the lower container portion (2) includes a port (20) for a connection line or connection hose in fluid communication with an air compressor.

16. The tire sealant container (1) of claim 15, wherein the upper container portion (3) includes a dome-shaped region (9) having an axially central adapter (10) with a port (11) for a connection line.

17. The tire sealant container (1) of claim 15, wherein the port (20) of the lower container portion (2) is formed by an adapter connected to the lower container portion (2).

18. The tire sealant container (1) of claim 15, wherein the port (20) of the lower container portion (2) is positioned eccentrically relative to a longitudinal axis of the tire sealant container (1).

19. The tire sealant container (1) of claim 15, wherein the lower container portion (2) includes a reception opening in which the port (20) is inserted and held.

20. The tire sealant container (1) of claim 19, wherein an edge region of the reception opening of the lower container portion (2) is pressed into the port (20) with a circumferential seal (6) clamped therebetween.
